(19) United States
(12) Patent Application Publication
(10) Pub. No.: US 2005/0133057 A1
(43) Pub. Date: Jun. 23, 2005

(54) Multi-sulcus flossing device

(76) Inventor: Keith I. Kirstein, New York, NY (US)

Correspondence Address: Keith I. Kirstein;Apartment #4A, 148 East 30th Street, New York, NY, 10016, US

(21) Appl. No.: 10/745,209

(22) Filed: Dec. 23, 2003

(51) Int. Cl. A61C 15/00

(52) U.S. Cl. 132/323

(57) ABSTRACT

A multi-sulcus flossing device for allowing one to floss more than one sulcus simultaneously and methods for using the device.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of the Invention

The present invention relates generally to flossing devices and methods and more specifically it relates to a multi-sulcus flossing device and methods for allowing one to floss more than one sulcus simultaneously.

2. Description of the Related Arts

It can be appreciated that flossing devices have been in use for years. Typically, flossing devices are comprised of a piece of floss being wound around two fingers. Another device that exists has a long handle with two prongs on one end of the handle connected with a single piece of floss.

While these devices may be suitable for the particular purpose to which they address, they are not suitable for flossing more than one sulcus simultaneously. The main problem with existing products is that they require a substantial amount of time to floss since they only floss a single sulcus at a time. Another problem is that they cause the user to experience discomfort for an extended period of time since they only floss a single sulcus at a time. Another problem with some existing products is that they are uncomfortable to use. Some products require one to wrap floss around the fingers and reach deep into the mouth. Another problem with some existing products is that they cannot be reused. Some products require one to discard both the floss and the flossing device when the floss's useful life has expired. Another problem with some existing products is that the prongs are not sturdy, which causes the prongs to bend excessively during the flossing process. This results in the floss not being taught during the flossing process.

In these respects, the multi-sulcus flossing device according to the present invention may substantially depart from the conventional concepts and designs of the prior art, and in so doing provides an apparatus primarily developed for the purpose of flossing more than one sulcus simultaneously.

### BRIEF SUMMARY OF THE INVENTION

In view of the foregoing disadvantages inherent in the known types of flossing devices now present in the prior art, the present invention provides a new multi-sulcus flossing device that can be utilized for flossing more than one sulcus simultaneously.

The general purpose of the present invention, which will be described subsequently in greater detail, is to provide a new multi-sulcus flossing device that has many of the advantages of the flossing devices mentioned heretofore and many novel features that result in a new multi-sulcus flossing device which is not anticipated, rendered obvious, suggested, or even implied by any of the prior art flossing devices, either alone or in any combination thereof.

Some embodiments of the invention include a piece of floss held between two holders that are attached to a support member. A second piece of floss is held between two other holders attached to the support member. The first two holders are configured so that the first piece of floss may be moved along a surface of a tooth and the second piece of floss may be moved along another surface of that tooth at substantially the same time that the first piece of floss is moved along the first surface of the tooth.

There has thus been outlined, rather broadly, some features of various embodiments of the invention in order that the detailed description thereof may be better understood, and in order that the present contribution to the art may be better appreciated. Additional features of the invention will be described hereinafter.

In this respect, before explaining the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purposes of the description and should not be regarded as limiting.

One object of the invention is to provide a device that allows one to floss more than one sulcus simultaneously.

Another object of the invention is to provide a device that decreases the time required to floss.

Another object of the invention is to provide a device that decreases the pain involved in flossing.

Another object of the invention is to provide a device that can be reused.

Another object of the invention is to provide a device that does not require one to wrap the floss around ones fingers to floss.

Another object of the invention is to provide a device that does not require one to reach deep into a mouth to floss.

Another object of the invention is to provide a device that keeps the floss relatively taught throughout the entire flossing process.

Another object of the invention is to provide a device that makes flossing animals quicker and safer.

Another object of the invention is to provide a device that makes cleaning objects that have several grooves separated by gaps quicker and easier.

Other objects and advantages of the present invention will become obvious to the reader and it is intended that these objects and advantages are within the scope of the present invention.

To the accomplishment of the above and related objects, this invention may be embodied in the form illustrated in the accompanying drawings or described in the specification, attention being called to the fact, however, that the drawings and the specification are illustrative only, and that changes may be made in the specific construction illustrated or described.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1—A perspective view of an embodiment of the invention.

FIG. 2—A perspective view of a base structure.

FIG. 3—A perspective view of a threading clip with the adjustable clips in the up position.

FIG. 4—A perspective view of a threading clip with the adjustable clips in the down position.

FIG. 5—A perspective view of an end clip with the adjustable clips in the down position.

FIG. 6—A perspective view of a floss dispenser.

### DETAILED DESCRIPTION OF THE INVENTION

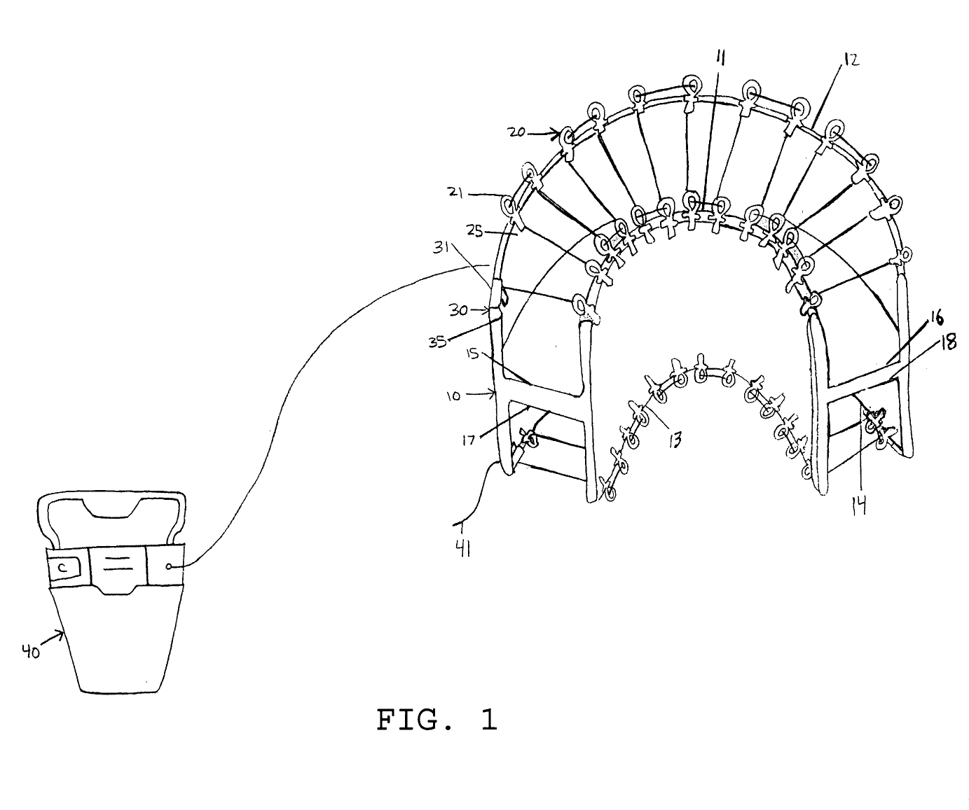

Turning now descriptively to the drawings, in which similar reference characters denote similar elements throughout the several views, the attached figures illustrate the FIG. 1 embodiment of a multi-sulcus flossing device, which comprises a base structure (10), threading clips (20), end clips (30), and a floss dispenser (40). The base structure (10) may be substantially U shaped (as depicted). One side of the base structure (10) has an upper inner rim (11) and upper outer rim (12), which form a rim around the entire edge of the structure except at the upper left end (15) and upper right end (16). On the other side of the base structure (10) a lower inner rim (13) and lower outer rim (14), which form a rim around the entire edge of the structure except at the lower left end (17) and lower right end (18). The threading clips (20) are two-sided structures with the bottom side (21) having a clip and the top side (25) having a small ring. The end clips (30) are ideally two-sided structures with the top side (31) having a clip and the bottom side (35) having a clip. The floss dispenser (40) is ideally a box containing dental floss (41) with a wax tip (43) and periodic colored stripes (42).

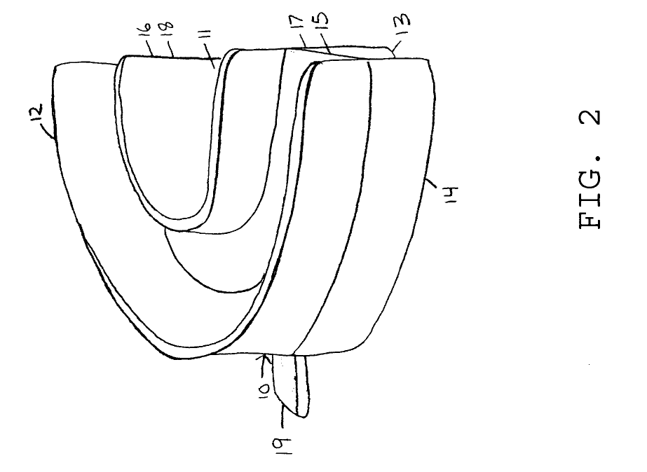

The base structure (10) of the FIG. 1 embodiment shown in FIG. 2, is substantially U shaped with one side having an upper inner rim (11) and upper outer rim (12), which form a rim around the entire edge of the structure except at the upper left end (15) and upper right end (16). On the other side of the lower base structure (10) is a lower inner rim (13) and lower outer rim (14), which form a rim around the entire edge of the structure except at the lower left end (17) and lower right end (18).

The FIG. 2 embodiment has a base structure (10) that is substantially U shaped so that the teeth will fit between the rims (11, 12, 13, 14) of the base structure (10). Different size and shape base structures (10) may be required for people with significantly different shaped teeth. Consequently, other embodiments have a base structure (10) having a gentler curve. Other embodiments have a base structure (10) having a sharper curve. Other embodiments have a base structure (10) with several different curves. Other embodiments have a base structure (10) which is completely straight. The reason for having different shapes for the base structure is to have a base structure that fits the given shape of a person's teeth. Some people's teeth are aligned in a more round manner which requires a gentler curve in the base structure (10). Some people's teeth are aligned more v like requiring a sharper curve in the base structure (10). Some people's teeth are not aligned next to one another requiring several different bends in the base structure (10). Some embodiments are only designed to floss a few sulci simultaneously. Therefore, in such embodiments, there is no substantial curve in the flossing area and the base structure (10) is straight.

The FIG. 2 embodiment has a panel (19) sticking out of the middle of the base structure (10). This panel (19) allows one to floss ones teeth without having to stick ones fingers in a mouth or the mouth of person or animal that the user is flossing.

Other embodiments use a small round panel sticking out of the middle of the base structure (10). Other embodiments use two panels in order to increase the control over the flosser.

Other embodiments have a base structure (10) made up of two separate base sections. The upper section is for the top teeth and the lower section is for the bottom teeth. In this case, the upper section will have an upper inner rim (11) and upper outer rim (12), and the lower section will have a lower inner rim (13) and a lower outer rim (14). The reason for having two separate sections is to make the device thinner to make it easier to fit in a mouth as well as making it easier to maneuver inside a mouth. Another advantage to having two base sections is that if the upper teeth and lower teeth are shaped significantly different one can select different base sections for the upper and lower teeth. Moreover, the upper section may be used alone. Likewise, the lower section may be used alone. Indeed, one section may be used to floss both the upper and bottom teeth at different times.

In FIG. 1, the base structure (10) is made of a hard, thin plastic that allows the floss (41) to remain taught during the flossing process and to allow the teeth to easily fit between the rims (11, 12, 13, 14). In addition, plastic is a safe material to put inside a mouth since it does not have any sharp edges.

Other embodiments use other thin hard materials such as metal, wood, and fiber glass for a base structure (10). These material all provide a slightly different amount of flex in the base structure, which slightly changes the flossing action of the base structure (10). Also these materials vary in cost, useful life and ease of cleaning make different materials ideal in different circumstances. Furthermore, the overall look of these materials may be dramatically different, which would make some users prefer one material over another.

Other embodiments use soft materials such as soft plastics and/or rubber for a base structure (10). The reason for using a soft material is to allow the base structure (10) to bend and contort during the flossing process allowing the floss (41) to reach into parts of the sulcus it otherwise could not. These materials all provide a different amount of flex in the base structure (10), which changes the flossing action of the base structure (10). Furthermore, the look of these materials may be different which makes some users prefer one material over another.

Other embodiments use thick pieces of soft and hard material for the base structure (10). The thick materials can provide a more stable base structure (10), which are especially useful when used in conjunction with more pliable materials. Furthermore, a thick base structure (10) can make it easier for the flosser to determine where the base structure's (10) rims (11, 12, 13, 14) are making it easier to place the teeth between the rims (11, 12, 13, 14).

Other embodiments use a combination of different materials to achieve the benefits of different types of materials.

The depths of the upper inner rim (11), the upper outer rim (12), the lower inner rim (13), and the lower outer rim (14) are 0.01 inches to 24 inches, preferably 0.1 inches to 1 inch, and more preferably 0.3 inches to 0.4 inches. The depth depends on the length of the teeth. The proper depth of the rims (11, 12, 13, 14) will allow one to floss the sulci without the teeth to be flossed touching the base structure (10) while still allowing the base structure (10) to be easily placed in the mouth.

Other embodiments are configured to allow the base structure (10) to touch only portions of the tooth or gums. This arrangement is preferable in some circumstances because it prevents the floss (41) on the threading clips (20) penetrating beyond a certain point. This can prevent damage to sulci as well as giving a guideline for the depth the floss (41) should penetrate into the sulci.

Other embodiments have a different height for the inside rims (11, 13) and the outside rims (12, 14). By having the rims (11, 12, 13, 14) at different heights it causes the floss to be applied at an angle. This angle allows the floss to contact the sulci at an angle, thereby creating a different flossing motion. Furthermore, keeping the floss (41) at an angle can make it easier to place the pieces of floss (41) in the embrasure.

The distance between the inside rim (11, 13) and the outside rim (12, 14) may be 0.01 inches to 36 inches, preferably 0.3 inches to 1.5 inches, and more preferably 0.7 inches to 0.8 inches. The distance should be such that it allows the teeth to slide comfortably between the rims (11, 12, 13, 14), but not so large that it is uncomfortable to use it in a mouth.

Other embodiments have the distances between rims (11, 12, 13, 14) vary at different points. This allows greater room between rims (11, 12, 13, 14) when necessary for comfort and less room between rims when necessary for comfort The distance between the outside of the ends (15, 16, 17, 18) may be between 0.001 inches to 200 inches, preferably 1.5 inches to 5 inches, and more preferably 2.75 inches to 3.25 inches. The distance should be such that it is wide enough to allow the entire flossing area to fit between it.

The distance between the inside of the ends (15, 16, 17, 18) may be between 0.03 inches and 199.9 inches, preferably between 1 to 2 inches, and more preferably between 1.4 and 1.6 inches. The distance should be such that it is wide enough to allow the entire flossing area to fit between it.

The distance between the middle of the outside rim (12, 14) and an imaginary point midway between the inside part of the ends (15, 16, 17, 18) may be between 0.1 and 36 inches, preferably between 1 and 5 inches, and more preferably between 2.5 and 3.5 inches. This distance should be such that it is long enough to allow the entire flossing area to fit between it.

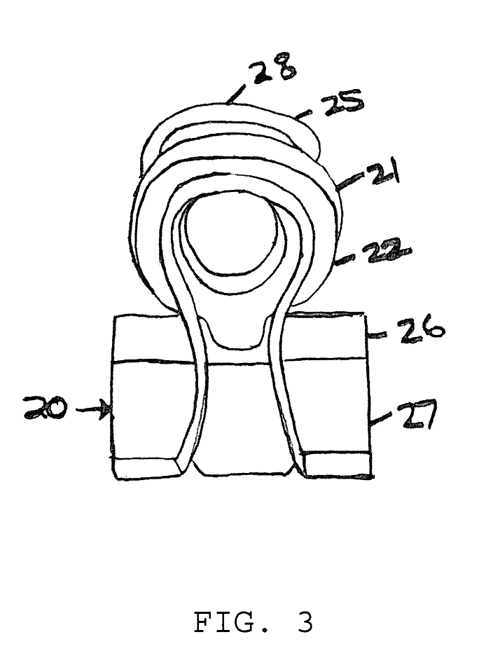

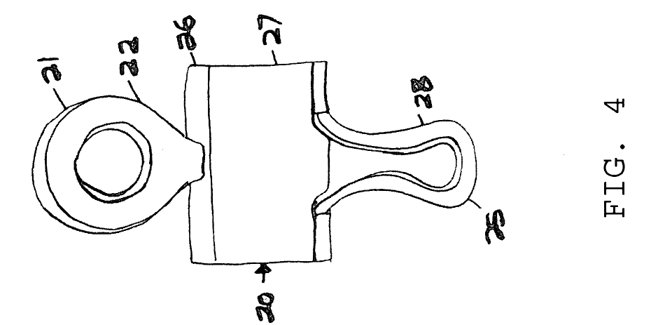

The threading clips (20) of the FIG. 1 embodiment, which are shown in FIGS. 3 and 4, are ideally two-sided structures with the bottom side (25) having a clip and the top side (21) having a small ring (22). The clip on the bottom side (25) attaches the threading clip (20) securely to the base structure (10) and the small ring (22) is used for threading the floss (41).

The bottom side (25) of the threading clip (20) includes a clip, which is similar in design to a binder clip. The clip has two flat narrow prongs (27) connected by a flat panel (26). A plastic wire (28) runs from corner to corner of the flat panel (26) and on the sides of the flat panel (26) where the prongs (27) are located. These plastic wires (28) allow the prongs (27) to be opened. In addition, the plastic wire (28) can fold down after the threading clip (20) is attached to the base structure (10) to allow the top side (21) to be easily threaded.

Other embodiments of the invention use flat T shaped panels instead of flat narrow prongs (27) to tighten the attachment of the threading clip (20) to the base structure (10). Other embodiments use flat T shaped panels with different lengths in order to fit the threading clips on the rims (11, 12, 13, 14).

Some embodiments of the invention have different types of clips for the bottom side (25) of the threading clip (20). Other embodiments attach the threading clips (20) to the base structure (10) by tying the threading clip (20) to the base structure (10) through holes or hooks in the threading clip (20) and holes in the base structure (10). Still other embodiments attach the threading clips (20) to the base structure (20) through Velcro strips on the bottom of the threading clip (21) and the rims of the base structure (10). Other embodiments have the threading clips (20) built into the base structure (10) eliminating the need for a bottom side (25) of the threading clip (20). Some embodiments allow for more secure attachment between the threading clip (20) and base structure (10). Other embodiments add to the ease of adjustability of the threading clip (20) on the base structure (10). Other embodiments make it easier for the floss (41) to be threaded through the top side (21) of the threading clip (20). Other embodiments are less expensive to manufacture. Depending on how important each of these factors is will determine which embodiment of the invention is employed.

Another embodiment of the invention flosses both left and right sulci of a tooth at the same time. This embodiment has threading clips (20) with two separate sets of prongs on it—each with a piece of floss (41). The two prongs are connected by a hinge at the end closest to the base structure (10). Between the prongs is a spring that pushes the prongs at the open end away from each other. On top of the rims (11, 12, 13, 14) is another rim that stands above the base structure (10), which forms a guard around both sides of the rims (11, 12, 13, 14). The threading clips (20) go between the guard rims and are held in place by the guard rims. The threading clips (20) are also on a spring but are held down by another guard rim made up of several relatively small pieces of metal connected by a relatively long plastic piece. This guard rim can be rolled back by turning a knob in the middle of the flosser that is connected to all of the second guard rims. Once the second guard rim is turned away the threading clips move up through the second guard rim and break away from each other allowing one to floss both left and right sulci simultaneously.

Other embodiments floss left and right and lower and upper sulci at the same time. One embodiment has threading clips (20) with two separate sets of prongs on it—each with a piece of floss (41). The two prongs are connected by a hinge at the end closest to the base structure (10). Between the prongs is a spring that pushes the prongs at the open end away from each other. On top of the rims (11, 12, 13, 14) is another rim that stands above the base structure (10), which forms a guard around both sides of the rims (11, 12, 13, 14). The threading clips (20) go between the guard rims and are held in place by the guard rims. The threading clips (20) are also on a spring but are held down by another guard rim made up of several small pieces of metal connected by a long plastic piece. This guard rim can be rolled back by turning a knob in the middle of flosser that is connected to all of the second guard rims. Once the second guard rim is turned away the threading clips move up through the second guard rim and break away from each other allowing one to floss both left and right sulci simultaneously. The bottom of the base structure (10) has the same set up as the top of the base structure (10). Therefore, when the knob is turned both top and bottom sulci are flossed simultaneously.

There are many ways that the floss may be configured to work with the invention. In the FIG. 1 embodiment, the top side of the threading clip (21) consists of a ring (22) that sits on top of the rim (11, 12, 13, 14) of the base structure (10). Other embodiments use loops of string or plastic that do not have a rigid shape for the top side (21). Other embodiments use clips for the top side (21). Other embodiments use sleeves of plastic, cloth, leather, or other fabric for the top side (21). Other embodiments have strings that the floss can be slid under that are tied onto the base structure. Other embodiments use holes in the rims (11, 12, 13, 14) of the base structure (10) for the top side (21). Other embodiments use slits in the rims (11, 12, 13, 14) of the base structure (10) for the top side (21). Other embodiments use a combination of several different top sides (21). The differences in these different methods is that some can easily be threaded, some allow thread to be easily pulled through them, some allow flossing to occur quicker, some are easily adjustable on the rims (11, 12, 13, 14), some are more cost effective, and some can be replaced if an individual threading clip (20) breaks. Depending on how important each of these factors is will determine which implementation to use.

The diameter of the ring (22) may be between 0.0001 inches and 12 inches, preferably, between 0.01 inches and 1 inch, and more preferably between 0.06 inches and 0.08 inches. The diameter should be such that it is large enough to allow the floss to pass through, but small enough to prevent the floss from moving around excessively in the ring (22).

The total height of a threading clip (20) may be between 0.001 inches and 24 inches, preferably, between 0.1 inches and 1 inch, and more preferably between 0.3 inches and 0.5 inches. This height should be sufficient to allow the teeth to be flossed, but not so great so as to make flossing uncomfortable.

The total width of a threading clip (20) may be between 0.0001 inches and 12 inches, preferably, between 0.01 inches and 1 inch, and more preferably between 0.05 inches and 0.07 inches. The width should be such that it is big enough to allow the threading clips (20) to be stable on rims (11, 12, 13, 14), but thin enough to allow all the threading clips to fit on the rims (11, 12, 13, 14).

The threading clip (20) may be a hard, thin plastic to allow the floss (41) to remain taught during the flossing process and to allow the teeth to easily fit between the threading clips (20). In addition, plastic is a safe material to put inside a mouth since it does not have any sharp edges.

Other embodiments use other thin hard materials such as metal, wood, or fiber glass for threading clips (20). These materials all provide a slightly different amount of flex in the threading clip (20), which slightly changes the flossing action of the threading clip (20). Also these materials vary in cost, useful life and ease of cleaning making different materials ideal in different circumstances. Furthermore, the overall look of these materials may be different which makes some users prefer one material over another.

Other embodiments use other soft materials such as soft plastics and rubber for the threading clip (20). The reason for using a soft material is to allow the threading clip (20) to bend and contort during the flossing process allowing the floss (41) to reach into parts of the sulcus it otherwise could not. These materials all provide a different amount of flex in the threading clip (20), which changes the flossing action of the threading clip (20). Furthermore, the overall look of these materials may be different which makes some users prefer one material over another.

Other embodiments use thick pieces of soft and hard materials for the threading clip (20). The thick materials can provide a more stable threading clip (20) especially useful with some of the softer materials. Furthermore, a thick threading clip (20) can make it easier for the flosser to determine where the threading clips (20) are making it easier to place the teeth between the threading clips (20).

Other embodiments use a combination of different materials to achieve an overall result that is not possible with one type of material.

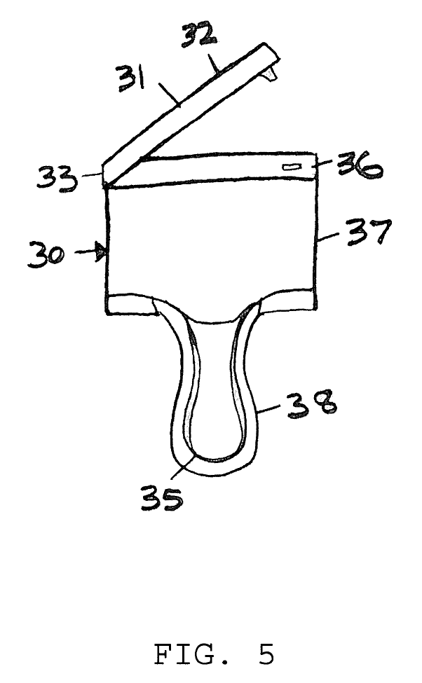

The end clips (30), depicted in FIG. 5, are two-sided structures with the top side (31) having a clip and the bottom side (35) having a clip. The clip on the bottom side (35) attaches to the base structure (10) and the clip on the top side (31) holds the floss (41) in place.

The bottom side (35) of the end clip (30) may include a clip, which is similar in design to a binder clip. The clip has two flat narrow prongs (37) connected by a flat panel (36), which has a plastic wire (38) that runs from corner to corner of the flat panel (36) on the sides of the flat panel (36) where the prongs (37) are located. These plastic wires (38) allow the prongs (37) to be opened up. In addition, the plastic wire (38) can fold down after the threading clip (20) is attached to the base structure (10) to allow the top side (31) to be easily threaded.

Other embodiments use flat T shaped panels instead of flat narrow prongs (37) to tighten the attachment of the end clip (30) to the base structure (10). Other embodiments use flat T shaped panels with different lengths in order to fit the end clips on the rims (11, 12, 13, 14).

Other embodiments have different types of clips for the bottom side (35) of the end clip (30). Other embodiments attach the end clips (10) to the base structure (10) by tying the end clip (30) to the base structure (10) through holes or hooks in the end clip (30) and holes in the base structure (10). Other embodiments attach the end clips (30) to the base structure (20) through Velcro strips on the bottom of the end clip (31) and the rims of the base structure (10). Other embodiments have the end clips (30) built into the base structure (10) eliminating the need for a bottom side (35) of the end clip (30). Some embodiments allow for more secure attachment between the end clip (30) and base structure (10). Other embodiments add to ease of adjustability of the threading clip (20) on the base structure (10). Other embodiments make it easier for the floss (41) to be threaded through the top side (31) of the end clip (30). Other embodiments are less expensive to manufacture. Depending on how important each of these factors is will determine which method implementation to use.

The clip on the top side (31) may include two flat rods (32) stacked on top of each other, which are attached at one end by a hinge (33) and can be clipped together at the other end. Other embodiments use a ring that can be used to tie the end of the floss (41) to hold the floss (41) in place. Other embodiments use a loop that can be used to tie the end of the floss (41) to hold the floss (41) in place. Other embodiments use a sleeve that can be used to tie the end of the floss (41) to hold the floss (41) in place. Other embodiments use a pole that can be used to tie the end of the floss (41) to hold the floss (41). Other embodiments use to vertical prongs that can be clipped together to hold the floss (41) in place. Other embodiments do not use end clips (30) and just have the floss (41) tied to a threading clip. Other embodiments do not use end clips (30) and just have the floss (41) tied to the base structure (10) either around the rims (11, 12, 13, 14) or through holes in the base structure (10). Other embodiments use a combination of two different top sides (31). The differences in these different methods is that some can easily be easily clipped and unclipped, some allow the floss to be quickly secured in place, some allow floss to be secured more firmly in place, some are easily adjustable on the rims (11, 12, 13, 14), some are more cost effective, and some can be replaced if an individual end clip (30) breaks.

The total height of an end clip (30) may be between 0.001 inches and 24 inches, preferably between 0.1 inches and 1 inch, and more preferably between 0.3 inches and 0.5 inches. This height should be such that it allows for enough height to allow the teeth to be flossed, but is not so high as to make flossing uncomfortable.

The total width of an end clip (30) may be between 0.0001 inches and 12 inches, preferably between 0.01 inches and 1 inch, and more preferably between 0.05 inches and 0.07 inches. The width should be such that it is big enough to allow the end clips (30) to be stable on rims (11, 12, 13, 14), but thin enough to allow all the end clips to fit on the rims (11, 12, 13, 14).

The end clip (30) can be made of a thin, hard plastic to allow the floss (41) to remain taught during the flossing process and to allow the teeth to easily fit between the end clip (30) and the threading clip (20).

Other embodiments use other thin hard materials such as metal, wood, and fiber glass for end clips (30). These materials all provide a slightly different amount of flex in the end clip (30), which slightly changes the flossing action of the end clip (30).

Other embodiments use other soft materials such as soft plastics and rubber for the end clip (30). The reason for using a soft material is to allow the end clip (30) to bend and contort during the flossing process allowing the floss (41) to reach into parts of the sulcus it otherwise might not. These materials all provide a different amount of flex in the end clip (30), which changes the flossing action of the threading clip (20).

Other embodiments use thick pieces of soft and hard materials for the end clip (30). The thick materials can provide a more stable end clip (30) especially useful with some of the softer materials. Furthermore, a thick end clip (30) can make it easier for the flosser to determine where the end clip (20) is makes it easier to place the teeth between the end clip (30) and the threading clip (20).

Other embodiments use a combination of different materials to achieve an overall result that is not possible with one type of material.

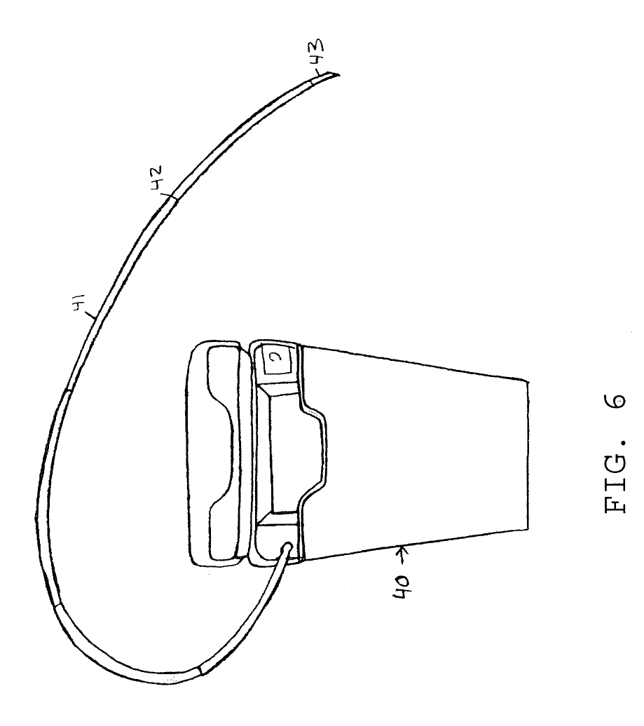

The floss dispenser (40) shown in FIG. 6, is a small container with floss (41) inside that can be dispensed by pulling on the end of the floss (41). The floss (41) in the flossing dispenser (40) has a wax tip (43) to allow for easier threading of the threading clips (20), and colored stripes (42) periodically on the floss (41) to make it easier to determine which part of the floss (41) has been used. Other embodiments do not have a wax tip (43). Other embodiments do not have colored stripes (42). A floss dispenser (40) is not necessary to use the invention as a piece of floss may be used in isolation.

Some embodiments have a floss dispenser (40) with a solid cylindrical plastic plug on the front of the piece of floss (41) and a slightly larger hollow cylindrical plastic receptor on the other end of the piece of floss (41). The plug of a fresh piece of floss (41) can be inserted into the receptor of the spent piece of floss (41) to allow one piece of floss (41) to be attached to another piece of floss (41). This makes rethreading the flosser easier and quicker. This connection can also be made by tying the one end of the floss (41) to an end of another piece of floss (41). All typical floss dispensers (40) can be used. Other embodiments use several small pieces of floss (41) for connecting each threading clip (20) on the inside rims (11, 13) with the threading clip (20) on the outside rims (12, 14). Clips and adhesives may also be used to attach a spent piece of floss to a fresh piece of floss for easy floss replacement.

The threading clips (20) connect to the base structure (10) by having the bottom side (25) of the threading clip (20) attach to a rim (11, 12, 13, 14) of the base structure (10). This connection is made in a variety of ways in different embodiments. Some embodiments have the threading clips (20) built into the base structure (10). The threading clips (20) may be attached along the top and bottom rims (11, 12, 13, 14) of the base structure (10) so that there is a threading clip (20) on the inside rim (11, 13) and outside rim (12, 14) for each embrasure. The two threading clips (20) together form a set of threading clips (20). Other embodiments do not have a set of threading clips (20) for all embrasures since some teeth may not need to be flossed.

The placement of the threading clips (20) may be determined by starting with the middle top embrasure in the correct alignment with the corresponding threading clip. One then works outward adding one set of threading clips (20) to the left and one set of threading clips (20) to the right of the existing threading clips (20). This process may then be repeated for the lower rim (12, 14) of the base structure (10). The user may start at whatever embrasure is most convenient.

A dentist or dental hygienist may determine the threading clips (20) placement. A mold of teeth position may also be employed to determine where the threading clips (20) are to be placed. The base structure (10) itself may be suitable to taking a mold that will reveal where the threading clips (20) should be placed. Other embodiments will only thread a small section of upper teeth, a small section of lower teeth, or a small section of lower teeth and upper teeth. In these cases a set of threading clips (20) is placed only for the intended section of teeth to be flossed.

The end clips (30) may connect to the base structure (10) by having the bottom side (35) of the end clip (30) attach to the rim (11, 12, 13, 14) of the base structure (10). This connection may be made in a variety of ways. The end clips (30) can be built into the base structure (10). The end clip (30) can be attached on the portion of the upper outer rim (12) next to the upper left end (15), and another end clip (30) can be attached on the portion of a lower rim (13, 14) next to the lower left end (17). In most embodiments of the invention, an end clip (30) is placed at the end of every piece of floss (41) to keep the floss taught and held in place. In other embodiments the floss (41) is tied off, fastened to the flosser, or held in place by a person, eliminating the need for one end clip (20) or all end clips (30).

In the FIG. 1 embodiment, the floss (41) first passes through the end clip (30) on the upper outer rim (12). The floss (41) is tightly clipped with the top side (31) of the end clip (30). The floss (41) is then strung through the top side (21) of the threading clip (20) across from the end clip (30).

The floss may also be fastened to a base structure by insertion into sleeves, using adhesives, clamps, or loops.

After the floss (41) is threaded through the first threading clip (20) on the upper inner rim (11) it is threaded through the next left most threading clip (20) on the upper inner rim (11). Next the floss (41) is threaded through the opposing threading clip (20) on the upper outer rim (12). Next the floss (41) is threaded through the next threading clip (20) on the upper outer rim (12). The floss (41) continues to be threaded in this fashion until it reaches the last threading clip (20) on an upper rim. If the last threading clip (20) threaded on an upper rim (11, 12) was on the upper inner rim (11) than the first threading clip (20) to be threaded on a lower rim (13, 14) is the right most threading clip (20) on the lower inner rim (13). If the last threading clip (20) threaded on an upper rim (11, 12) was on the upper outer rim (12) than the first threading clip (20) to be threaded on a lower rim (13, 14) is the right most clip on the lower outer rim (14). The threading clips (20) on the lower rims (13, 14) are then threaded in the same fashion that the threading clips (20) on the upper rims (11, 12) were threaded except that they are threaded right to left. The last clip to be threaded on the bottom rim (13, 14) is the end clip (30) on the lower rim (13, 14). Other embodiments string the lower rims (13, 14) and then the upper rims (11, 12). Other embodiments string the floss (41) right to left.

Other embodiments string the upper rims (11, 12) and lower rims (13, 14) separately. Other embodiments start the stringing on the outer rims (12, 14). Other embodiments don't string the threading clips (20) in order. The order of flossing is not important, but is simply a matter of personal preference of the user.

One operates the FIG. 1 embodiment of the invention by first placing the floss (41) pieces on the upper rims (1 l, 12) between all the embrasures of the upper teeth. Second, one flosses all the right sulci of the upper teeth by moving the floss (41) into the right sulci and moving the base structure (10) up and down in a flossing motion with the hands. Third, one flosses all the left sulci of the upper teeth by moving the floss (41) into the left sulci and moving the base structure (10) up and down in a flossing motion. Fourth, one repeats this process with the floss on the bottom rims (13, 14) to floss the lower teeth sulci.

One operates embodiments that floss both left and right sulci at the same time in the same fashion as the FIG. 1 embodiment, except one only has to perform the flossing action one time for the upper and lower sulci since both the right and left sulci are flossed simultaneously.

One operates embodiments that floss both upper and lower sulci at the same time in the same fashion as the FIG. 1 embodiment, except one only has to perform the flossing action one time for the left and right sulci since both the upper and lower sulci are flossed simultaneously.

One operates embodiments that floss only a small portion of the upper or lower sulci at once in the same fashion as the FIG. 1 embodiment except one has to floss to floss the upper and lower teeth several times in order to floss all sulci.

The base structure (10) in the FIG. 1 embodiment adds to the functionality of the invention by its U shape and rims (11, 12, 13, 14). The U shape allows the users teeth to be positioned inside the rims (11, 12, 13, 14). These rims (11, 12, 13, 14) allow the floss (41) to reach fully into the user's embrasures so that multiple sulci can be flossed simultaneously. The firmness of the base structure (10) also provides a sturdy platform for the threading clips (20) to sit on so that the floss (41) remains taught throughout the flossing process.

The design of the threading clips (20) in the FIG. 1 embodiment allows them to be adjusted along the base structure (10) so that the flossing device can be easily set up. In addition, the ring (22) of the threading clips (20) allows the floss (41) to be easily threaded initially and also allows the floss (41) to be easily pulled through the threading clips (20) when the floss (41) needs to be changed. Also, having the floss (41) slightly elevated above the rims (11, 12, 13, 14) further increases the comfort one experiences when flossing. By reducing the size of the rims (11, 12, 13, 14) and increasing the height of the top side of the threading clip (21) it is possible to floss teeth without placing them down into the rims (11, 12, 13, 14) of the base structure (10). In this situation, the end clips (30) would also have to be elevated as well, or an additional threading clip (20) would need to be added next to each end clip (30).

The design of the end clips (30) in the FIG. 1 embodiment allows them to be easily adjusted along the base structure (10) to assist in the set up process. In addition, they allow the floss (41) to be easily clipped and unclipped, which enables the floss (41) to be unthreaded during the set up process and allow a fresh section of floss (41) to be pulled through during regular operation.

The design of the floss dispenser (40) allows for easy threading of the threading clips (20) and allows for the easy recognition of the portion of used floss (41).

To set up the threading clips (20) in the FIG. 1 embodiment, the user, or someone assisting the user must first determine the number of embrasures one has in their upper and lower teeth. Then one would put a threading clip (20) on the inner rims (11, 13) and outer rims (12, 14) approximately where each embrasure was located. The threading clips (20) for the middle embrasure may be placed directly in the middle of the upper inner rim (11) and upper outer rim (12). In addition, the two end clips (30) could be clipped into place, one on the portion of the upper outer rim (12) next to the upper left end (15) and one on the portion of the upper outer rim (12) next to the upper right end (16). The floss (41) could then be threaded through the left set of threading clips (20), then through the middle set of threading clips (20), and finally through the right set of threading clips (20). The floss (41) could be held in place by holding the floss (41) tight against the base structure (10) using ones fingers or by clipping it in place using the end clips (30). The user could then use the trial and error method to ensure that the three sets of threading clips (20) were placed in such a manner that the floss (41) slides easily between all three embrasures. The floss (41) could then be removed from the threading clips (20). Next, the user could adjust the sets of threading clips (20) to the left and right of the previous threading clips (20). The user could adjust these two sets of threading clips (20) until the floss (41) slides easily between all five of the user's embrasures. This process is repeated until all the threading clips (20) have been properly placed on the upper rims (11, 12). After the threading clips (20) have been properly placed on the upper rims (11, 12) the end clips (30) are moved to the lower rims (13, 14) and the process is repeated for the lower rims (13, 14). Once all threading clips (20) have been properly placed, one end clip (30) could be placed on the portion of the upper outer rim (12) next to the upper left end (15) and one end clip (30) could be placed on the portion of a lower rim (13, 14) next to the lower left end (17). Then the floss (41) could be threaded completely through the two end clips (30) and all the threading clips (20). At this point the flossing device can be used to floss multiple sulci simultaneously.

Molds and imprints of the subject's teeth may be used to simplify the setup procedure. Moreover, since the distance between sulci in different subjects mouths may not vary greatly, pre-configured flossing devices may be employed. With such devices, the necessary adjustments for adaptation to individual mouth configurations may by minimal or non-existent.

Electronic embodiments of the invention also have the ability to “remember” the appropriate distance between strands of floss for a given user. Thus, when a given user sets this embodiment of the invention for his or her use, the invention automatically configures itself so that it can effectively floss that user's teeth. Such simple electronic and mechanical functionality are well known in the art.

With respect to the above description, the optimum dimensional relationships for the parts of the invention, to include variations in size, materials, shape, form, function and manner of operation, assembly and use, are readily apparent and obvious to one skilled in the art, and all equivalent relationships to those illustrated in the drawings and described in the specification are encompassed by the present invention. The foregoing description is intended to illustrate and not limit the scope of the invention. Other aspects, advantages, modifications, and equivalents are within the scope of the following claims.

Further, since numerous modifications and changes will readily occur to those skilled in the art, it is not desired to limit the invention to the exact construction and operation shown and described, and accordingly, all suitable modifications and equivalents are within the scope of the invention.

1. A multi-sulcus flossing device comprising:
a first piece of floss held between a first holder and a second holder wherein said first and second holders are attached to a support member;
a second piece of floss held between a third holder and a fourth holder wherein said third and fourth holders are attached to the support member;
said first and second holders being configured so that said first piece of floss may be moved along a first surface of a first tooth and said second piece of floss may be moved along a second surface of said first tooth at substantially the same time that said first piece of floss is moved along the first surface of the first tooth.

2. The multi-sulcus flossing device of claim 1 wherein said first and second pieces of floss are on a continuous length of floss.

3. The multi-sulcus flossing device of claim 1 wherein said first and second surfaces of said first tooth are on opposite sides of said tooth.

4. The multi-sulcus flossing device of claim 1 further comprising:
a third piece of floss held between a fifth holder and a sixth holder wherein said fifth and sixth holders are attached to the support member;
said fifth and sixth holders being configured so that said third piece of floss may be moved along a first surface of a second tooth and at substantially the same time that said first piece of floss is moved along the first surface of said first tooth.

5. The multi-sulcus flossing device of claim 1 wherein said support member is attached to a base member that is substantially u shaped.

6. The multi-sulcus flossing device of claim 5 wherein said first, second, third, and fourth holders are comprised of clips which hold said first and second pieces of floss substantially still.

7. The multi-sulcus flossing device of claim 1 wherein said first, second, third, and fourth holders may be moved along said support member so that said first piece of floss and said second piece of floss may floss a third tooth having different dimensions than said first tooth.

8. A method of using the multi-sulcus flossing device of claim 1 comprising the steps of:
moving the multi sulcus flossing device such that said first piece of floss is moved along said first surface of said first tooth and said second piece of floss is moved along said second surface of said first tooth at substantially the same time that said first piece of floss is moved along the first surface of said first tooth.

9. The method of using the multi-sulcus flossing device of claim 8 further comprising the steps of:
moving said first, second, third, and fourth holders along said support member so that said first piece of floss and said second piece of floss floss a third tooth having different dimensions than said first tooth.

10. The method in claim 8 further comprising the step of:
moving the multi sulcus flossing device such that a third piece of floss is moved along a first surface of a second tooth at substantially the same time that said first piece of floss is moved along the first surface of said first tooth.

11. A multi-sulcus flossing device comprising:
a first piece of floss held between first floss holding means and second floss holding means;
a second piece of floss held between a third floss holding means and a fourth floss holding means;
said first and second holding means being configured so that said first piece of floss may be moved along a first surface of a first tooth and said second piece of floss may be moved along a second surface of said first tooth at substantially the same time that said first piece of floss is moved along the first surface of the first tooth.

12. The multi-sulcus flossing device of claim 11 further comprising adjusting means for varying the distance between the first piece of floss held between the first and second floss holding means and the second piece of floss held between the third and fourth floss holding means.

13. The multi-sulcus flossing device of claim 12 further comprising distance variation means for varying the distance between the first and second floss holding means.

14. The multi-sulcus flossing device of claim 11 further comprising a third piece of floss held between a fifth floss holding means and a sixth floss holding means;
said fifth and sixth floss holding means being configured so that said third piece of floss may be moved along a first surface of a second tooth and at substantially the same time that said first piece of floss is moved along the first surface of said first tooth.

15. The multi-sulcus flossing device of claim 14 further comprising adjusting means for varying the distance between the first piece of floss held between the first and second floss holding means and the second piece of floss held between the third and fourth floss holding means.

16. The multi-sulcus flossing device of claim 15 further comprising distance variation means for varying the distance between the first and second floss holding means.

17. A multi-sulcus flossing device comprising:
a first piece of floss held between a first holder and a second holder wherein said first and second holders are attached to a support member;
a second piece of floss held between a third holder and a fourth holder wherein said third and fourth holders are attached to the support member;
said first and second holders being configured so that said first piece of floss may be moved into a first sulcus and said second piece of floss may be moved into a second sulcus at substantially the same time that said first piece of floss is moved into the first sulcus.

18. The multi-sulcus flossing device of claim 17 wherein said first and second pieces of floss are on a continuous length of floss.

19. The multi-sulcus flossing device of claim 18 wherein said first and second sulci are on opposite sides of a tooth.

20. The multi-sulcus flossing device of claim 17 further comprising:
a third piece of floss held between a fifth holder and a sixth holder wherein said fifth and sixth holders are attached to the support member;
said fifth and sixth holders being configured so that said third piece of floss may be moved into a third sulcus at substantially the same time that said first piece of floss is moved into said first sulcus.
